(19) United States
(12) Patent Application Publication
(10) Pub. No.: US 2009/0255199 A1
(43) Pub. Date: Oct. 15, 2009

(54) Concrete Floor System Incorporating Foundation Footing

(76) Inventors: Craig Wallace Lonsdale, Queenstown (NZ); Peter Raymond Harris, Queenstown (NZ)

Correspondence Address: JOHN ALEXANDER GALBREATH, 2516 CHESTNUT WOODS CT, REISTERSTOWN, MD, 21136, US

(21) Appl. No.: 12/090,863

(22) PCT Filed: Oct. 19, 2006
(86) PCT No.: PCT/NZ2006/000267

§ 371 Date: Jun. 16, 2008

(30) Foreign Application Priority Data
Oct. 19, 2005 (NZ) 542068

(51) Int. Cl. E02D 27/00; E02D 5/66; B22D 15/00; B29C 33/56; E04C 2/20

(52) U.S. Cl. 52/292; 249/13; 249/111; 249/114.1; 52/309.1; 52/742.14

(57) ABSTRACT

This invention relates to apparatus for use in a concrete floor system, incorporating a foundation footing, for a building, a foundation footing or a concrete floor system including the apparatus and a method of construction of such a concrete floor system, wherein the apparatus includes a moulding for a foundation footing, including: a first wall section, a second wall section and a bottom section; said sections being connected together to present a substantially u-shaped cross-section, and wherein the first wall section is taller than the second wall section.

### FIELD OF THE INVENTION

This invention relates to apparatus for use in the construction of a concrete floor system or foundation for a building, a footing for a building and a method of construction thereof.

### BACKGROUND

It is common for the foundation of a building to be formed primarily out of poured concrete.

The footings of a foundation are those parts of the foundation which will be underneath the load-bearing walls of the finished building, and therefore will carry the most weight. It is therefore usual for the footings of the foundation to be thicker than the main part of the foundation.

A complete concrete floor system incorporates both footings and a slab which together form the foundation for the building. This concrete floor system may be coated with a lining material such as vinyl, tiles or carpet, painted or left untreated (depending on the desired use) to provide a finished floor for the ground floor of the building.

The standard practice to prepare a site for the laying of a foundation is to remove the top soil so that the slab will rest on the harder substrate below. The paths of the footings are then dug as trenches deeper into the substrate.

The slab site may then be lined with a damp-proof membrane. It is known to place thin sheets of polystyrene across the flat areas under the main part of the foundation in order to provide a flat smooth surface with good insulating properties on which the concrete foundation can be poured.

In order to form the mould into which the concrete will be poured, wooden planks are used to form boxing around the edges of the footing trenches. These planks must be properly aligned to contain the fluid concrete and are pegged into position to withstand the weight of the concrete.

Once the boxing has been completed, standard metal reinforcing is placed in the footing trenches. The concrete is then poured into the mould. Once the concrete has cured sufficiently to be self-supporting, the wooden boxing is removed.

This industry-standard method is labour-intensive, both in setting up and in removing the mould. The resulting foundation may be insulated under the main part of the slab, but not under the footings, and the sides of the foundation which are above ground level are unsightly, rough concrete.

### SUMMARY OF INVENTION

It is an object of the present invention to provide at least one of the following:
a mould for the footings of foundation which is quick and easy to set up and provides insulation and an attractive finish for the building foundation;
a foundation footing which incorporates a mould having those characteristics and meets the requirements of a footing; and
a concrete floor system, incorporating foundation footings, which is insulated from the ground.

The present invention comprises a moulding for a foundation footing, including:
(i) a first wall section;
(ii) a second wall section; and
(iii) a bottom section

said sections being connected together to present a substantially u-shaped cross-section and wherein the first wall section is taller than the second wall section.

The present invention further comprises a foundation footing, including:
(i) a moulding including a first wall section, a second wall section and a bottom section, said sections being connected together to present a substantially u-shaped cross-section and wherein the first wall section is taller than the second wall section;
(ii) reinforcing;
(iii) concrete filling the moulding and surrounding the reinforcing.

The present invention further includes a concrete floor system or foundation including:
(i) a moulding including a first wall section, a second wall section and a bottom section, said sections being connected together to present a substantially u-shaped cross-section and wherein the first wall section is taller than the second wall section;
(ii) sheets of thermally insulating material underlying the main floor area;
(iii) reinforcing;
(iv) concrete continuously filling the moulding, covering the sheets and surrounding the reinforcing.

Preferably the moulding is made of polystyrene. Preferably the moulding is self-supporting.

The moulding may also include an outer coating on the first wall section, selected from the list comprising: cement sheet, smooth plaster finish, texture coating.

The present invention yet further comprises a method of forming a concrete floor system for a building, including the steps of:
(i) preparing a flat slab site;
(ii) laying for each footing a moulding including a first wall section, a second wall section and a bottom section; said sections being connected together to present a substantially u-shaped cross-section and wherein the first wall section is taller than the second wall section, such that the first wall sections of the mouldings define a mould for the concrete floor system;
(iii) placing reinforcing in each moulding;
(iv) pouring concrete into the mould.

The method may further include the step laying sheets of polystyrene, or some other thermally insulating material, across the main part of the mould. Preferably the bottom of the moulding is on substantially the same level as the bottom of the thermally insulating sheets.

### BRIEF DESCRIPTION OF DRAWINGS

By way of example only, a preferred embodiment of the present invention is described in detail with reference to the accompanying drawings, in which:

FIG. 1 is a cross-section of a moulding for a foundation footing.

FIG. 2 is a cross-section of part of a concrete floor system incorporating the moulding.

### BEST METHOD OF CARRYING OUT THE INVENTION

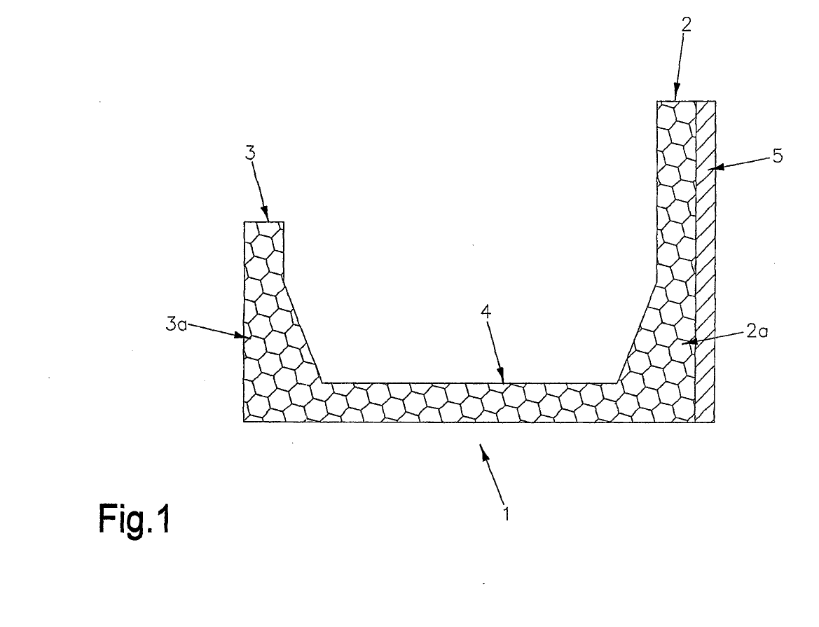

Referring to FIG. 1, a moulding 1 for a footing of a foundation is formed of polystyrene. The moulding is continuously formed with a first wall 2 opposite a second wall 3, with a bottom section 4 seamlessly connecting the first wall 2 to the second wall 3. The lower sections 2a and 3a of first wall 2 and second wall 3 gradually widen towards the interior of the moulding. The wider lower sections 2a and 3a improve the strength of first wall 2 and second wall 3 where the load is greatest. However, the wider sections 2a/3a may be replaced by sections the same width as the remainder of the wall, if the additional strength is not needed.

First wall 2 is taller than second wall 3 and has a layer of outer coating 5 on its exterior side. The outer coating may preferably be a texture coating. This outer coating 5 forms the exterior of the finished foundation, and can then be painted to match the exterior of the building, without the need for any further treatment, to produce an aesthetically pleasing result.

The moulding 1 can be extruded in pre-cut lengths, or custom-made to match the dimensions of a specific job, either on-site or off-site. The moulding 1 is not limited to straight lengths, but can be manufactured as a curved length.

In order to achieve a desired length of moulding 1, multiple pre-cut lengths can be placed adjacent to each other, and optionally secured together by glue or other known means. Pre-cut lengths of moulding 1 can also be cut down where a shorter length is desired.

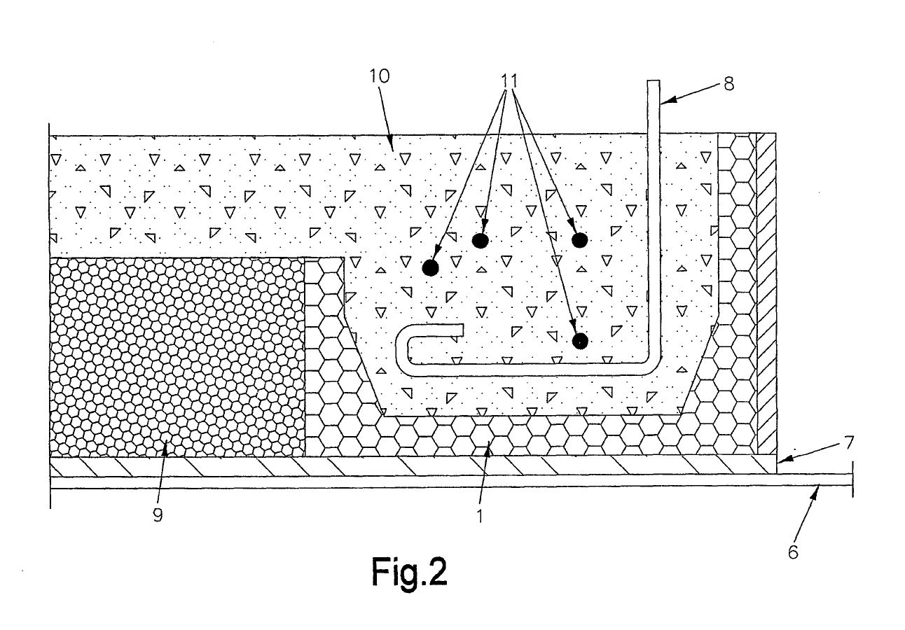

Referring to FIG. 2, the slab site 6 is pre-prepared by removing the top soil according to standard practice and using known techniques, and is lined with a damp-proof membrane 7. There is no need to dig trenches for the footings.

The moulding 1 is placed in position for the footings, and known reinforcing stirrups 8 are placed on known reinforcing chairs in each moulding 1, along with longitudinal reinforcing rods 11. There is no need to use pegs to hold up the moulding 1, which is self-supporting. However, on some sites it may be desirable to place some pegs against the moulding 1 to hold it in place, prop or brace it. The main part of the slab site between the footings is lined with polystyrene sheets 9 to form a continuous polystyrene mould. The bottom of the moulding 1 is on substantially the same level as the bottom of the polystyrene sheets 9. Alternatively, ordinary fill can be substituted for the polystyrene sheets 9. If the building requires piles, holes can be cut in the moulding 1 to accommodate the piles.

Concrete 10 is then poured into the mould in a continuous pour across the main floor of the foundation and through the footings to complete the foundation. Once the concrete 10 is cured, the concrete floor system is complete. The mould forms part of the finished foundation, and does not need to be removed.

In an alternative embodiment (not shown), first wall 2 is the same height as second wall 3 and has no texture-coating. This embodiment is suitable for footings situated within the main part of the slab, rather than at the exterior of the foundation.

In another embodiment, the slab site preparation may include digging trenches for the footings, and the moulding 1 may be placed within these trenches.

It will be apparent to one skilled in the art that a foundation footing according to the present invention results in a foundation which is thermally insulated not only under the main floor, but also throughout the footing and under the walls, which provides an advantage over existing systems, which do not provide any thermal insulation under the walls of the building.

1. A moulding for a foundation footing, including:
(i) a first wall section;
(ii) a second wall section; and
(iii) a bottom section;
said sections being connected together to present a substantially u-shaped cross-section, and wherein the first wall section is taller than the second wall section.

2. A moulding for a foundation footing according to claim 1 wherein the moulding is made from a thermally insulating material.

3. A moulding for a foundation footing according to claim 2 wherein the moulding is made from polystyrene.

4. A moulding for a foundation footing according to claim 1, wherein the moulding is self-supporting.

5. A moulding for a foundation footing according to claim 1, wherein the lower part of at least one of the first wall section and the second wall section is thicker than the top of that section.

6. A moulding for a foundation footing according to claim 1, wherein the first wall section further includes an outer coating.

7. A moulding for a foundation footing according to claim 6, wherein the outer coating is selected from the list comprising: cement sheet, smooth plaster finish, texture coating.

8. A foundation footing, including:
(i) a moulding including a first wall section, a second wall section and a bottom section, said sections being connected together to present a substantially u-shaped cross-section and wherein the first wall section is taller than the second wall section;
(ii) reinforcing;
(iii) concrete filling the moulding and surrounding the reinforcing.

9. A foundation footing according to claim 8 wherein the moulding is made from a thermally insulating material.

10. A foundation footing according to claim 9 wherein the moulding is made from polystyrene.

11. A foundation footing according to claim 8, wherein the moulding is self-supporting.

12. A foundation footing according to claim 8, wherein the lower part of at least one of the first wall section and the second wall section is thicker than the top of that section.

13. A foundation footing according to claim 8, wherein the first wall section further includes an outer coating.

14. A foundation footing according to claim 13, wherein the outer coating is selected from the list comprising: cement sheet, smooth plaster finish, texture coating.

15. A foundation footing according to claim 8, wherein the reinforcing includes stirrups.

16. A foundation footing according to claim 8, wherein the reinforcing includes longitudinal reinforcing rods.

17. A concrete floor system for a building, including:
(i) a moulding including a first wall section, a second wall section and a bottom section, said sections being connected together to present a substantially u-shaped cross-section and wherein the first wall section is taller than the second wall section;
(ii) sheets of thermally insulating material underlying the main floor area;
(iii) reinforcing;
(iv) concrete continuously filling the moulding, covering the sheets and surrounding the reinforcing.

18. A concrete floor system for a building according to claim 17 wherein the moulding is made from a thermally insulating material.

19. A concrete floor system for a building according to claim 18 wherein the moulding is made from polystyrene.

20. A concrete floor system for a building according to claim 17, wherein the moulding is self-supporting.

21. A concrete floor system for a building according to claim 17, wherein the bottom of the moulding is on substantially the same level as the bottom of the sheets of thermally insulating material.

22. A concrete floor system for a building according to claim 17, wherein the entire floor system is under-laid with a damp-proof membrane.

23. A concrete floor system for a building according to claim 17, wherein the lower part of at least one of the first wall section and the second wall section is thicker than the top of that section.

24. A concrete floor system for a building according to claim 17, wherein the first wall section further includes an outer coating.

25. A concrete floor system for a building according to claim 24, wherein the outer coating is selected from the list comprising: cement sheet, smooth plaster finish, texture coating.

26. A method of forming a concrete floor system for a building, including the steps of:
(i) preparing a flat slab site;
(ii) laying for each footing a moulding including a first wall section, a second wall section and a bottom section, said sections being connected together to present a substantially u-shaped cross-section wherein the first wall section is taller than the second wall section, such that the first wall sections of the mouldings define a mould for the concrete floor system;
(iii) placing reinforcing in each moulding;
(iv) pouring concrete into the mould.

27. A method of forming a concrete floor system for a building according to claim 26 wherein the moulding is made from a thermally insulating material.

28. A method of forming a concrete floor system for a building according to claim 27 wherein the moulding is made from polystyrene.

29. A method of forming a concrete floor system for a building according to claim 26, wherein the moulding is self-supporting.

30. A method of forming a concrete floor system for a building according to claim 26, including the further step of laying polystyrene sheets across the main part of the mould.

31. A method of forming a concrete floor system for a building according to claim 30, wherein the polystyrene sheets lie flush with the second wall section.

32. A method of forming a concrete floor system for a building according to claim 26, further including the step of lining the slab site with a damp-proof membrane.

33. A method of forming a concrete floor system for a building according to claim 26, wherein the lower part of at least one of the first wall section and the second wall section is thicker than the top of that section.

34. A method of forming a concrete floor system for a building according to claim 26, wherein the first wall section further includes an outer coating.

35. A method of forming a concrete floor system according to claim 34, wherein the outer coating is selected from the list comprising: cement sheet, smooth plaster finish, texture coating.

36. A method of forming a concrete floor system for a building according to claim 26, further including the step of placing pegs against the moulding.

37. A method of forming a concrete floor system for a building according to claim 26, further including the step of cutting holes in the moulding to accommodate piles.
